(19) United States
(12) Patent Application Publication
(10) Pub. No.: US 2025/0270981 A1
(43) Pub. Date: Aug. 28, 2025

(54) ENERGY STORAGE AND RETRIEVAL SYSTEM

(71) Applicant: Gaurav Bazaz, Montvale, NJ (US)

(72) Inventor: Gaurav Bazaz, Montvale, NJ (US)

(73) Assignee: Spar Systems Inc., Montvale, NJ (US)

(21) Appl. No.: 19/048,516

(22) Filed: Feb. 7, 2025

Related U.S. Application Data
(60) Provisional application No. 63/556,531, filed on Feb. 22, 2024.

(51) Int. Cl. F03G 3/08; H02K 7/02

(52) U.S. Cl. CPC F03G 3/08; H02K 7/025

(57) ABSTRACT

An energy storage and retrieval system including a lifting post, power rotors, and a generator is provided. The power rotors are movable along the lifting post between a first end and a second end. The power rotors include a hub and a plurality of rotor blades attached thereto. The rotor blades are configured to interact with a fluid medium surrounding the power rotors to generate rotational motion of a rotator tube of the lifting post, through the hub, which is converted into electrical energy. The power rotors are moved from away from the first end along the lifting post against a bias of a resistive force, and locked in position for storing potential energy in the system. The power rotors are released from the locked position and allowed to move towards the lifting post under an influence of the resistive force for retrieving stored energy in the system.

### CROSS REFERENCE TO RELATED APPLICATION

This application claims priority to U.S. provisional patent application No. 63/556,531 filed Feb. 22, 2024, the contents of which are hereby incorporated by reference in their entirety.

### TECHNICAL FIELD

The present disclosure relates to energy storage systems, primarily designed for storing energy for a grid. More specifically, the present disclosure relates to systems for storing energy in a set of rotors that are lifted against gravity in a fluid body, for long duration and large-scale applications.

### BACKGROUND

The integration of renewable energy sources into an electrical grid has become increasingly critical in a pursuit of sustainable and environmentally friendly energy production. However, the intermittent nature of renewable energy sources, such as solar and wind, presents significant challenges for energy reliability and grid stability. Conventional energy storage solutions, such as lithium-ion batteries, have addressed short-to-medium-term needs, but frequently lack the cost-effectiveness, scalability, and sustainability required for long-duration storage, which is crucial for maintaining supply and demand over extended periods.

Current grid-level energy storage systems play a pivotal role in energy arbitrage, frequency regulation, and load leveling, but are limited by energy capacity, degradation over time, and environmental impact. For instance, chemical batteries suffer from limited charge-discharge cycles and long-term capacity loss, while pumped hydroelectric storage, although effective for large-scale energy storage, is geographically constrained and associated with high initial capital costs and environmental concerns.

Furthermore, the increasing global demand for electricity, combined with a pressing need to decarbonize an energy sector, necessitates innovative energy storage solutions that are not only capable of long-duration storage but are also economically viable, highly efficient, scalable, and have minimal environmental impact. There is, therefore, a significant need for advancements in the energy storage technology that can bridge a gap between an availability of renewable energy and a constant demand across the grid, and facilitating a more resilient, reliable, and sustainable energy landscape.

### SUMMARY

The following presents a simplified summary of various aspects of this disclosure in order to provide a basic understanding of such aspects. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

The present disclosure relates to an energy storage and retrieval system designed for long-duration storage applications for a grid. The present disclosure aims to overcome the limitations of existing technologies by offering a solution that is not only more efficient and cost-effective, but also environmentally sustainable, thereby supporting a broader integration of renewable energy sources into a grid and enhancing an overall stability and reliability of an energy supply system.

The present disclosure pertains to an energy storage and retrieval system, which includes a lifting post including a rigid core, and a rotator tube mounted on the rigid core via one or more bearings. The rotator tube is configured to spin/rotate about the rigid core. The system includes one or more power rotors being movable along a length/height of the lifting post. The power rotors include a hub movably connected along the rotator tube, the hub being movable between a first end and a second end of the lifting post, and a plurality of rotor blades attached to the hub, where the rotor blades are configured to rotate the rotator tube through the hub when the plurality of rotor blades interact with a fluid medium. The power rotors are configured to store potential energy when moved towards the second end along the lifting post against a resistive force, and are configured to interact with the fluid medium when the power rotors are released to move towards the first end by the resistive force, causing the potential energy to be converted to rotational motion of the rotator tube. The rotational motion of the rotator tube may be either converted to electrical energy by a generator rotationally locked to the rotator tube, and/or drive a mechanical load rotationally locked to the rotator tube.

The system has several advantages: (a) there is no self-discharge, so the stored energy is perfectly retained, (b) since there is no self-discharge, stored energy can be retained for extremely long periods without any losses, (c) provides nearly 100% depth of discharge on each cycle without any degradation of performance, (d) has an extremely large number of charge-discharge cycles, likely in the millions, (e) the system allows nearly 100% round-trip efficiency, (f) is highly scalable to very large energy storage magnitudes, (g) promotes safety and reliability, by eliminating need to use any toxic substances, and presents no hazard, (h) is highly environmentally friendly, (i) has very low operating cost and simple construction, and (j) can be placed in almost any geographical location. Most importantly, the combination of the above features allows the system to achieve a very low Levelized Cost of Storage (LCOS), which is a very important parameter for selection of energy storage and retrieval systems for grid storage.

### BRIEF DESCRIPTION OF THE DRAWINGS

FIG. 1 illustrates a schematic view of components and assembly of an energy storage and retrieval system, in accordance with an embodiment of the present disclosure.

FIG. 2 illustrates a schematic view depicting an operation of the system, where a power rotor is being discharged, and carries out rotational motion in a process to release the stored energy, in accordance with an embodiment of the present disclosure.

FIG. 3 illustrates a top view depicting a motion of the power rotor under an influence of a fluid medium, as the stored energy is discharged, in accordance with an embodiment of the present disclosure.

FIG. 4(a) to FIG. 4(d) illustrate schematic views depicting the operation of the system in different stages of charging/storage and discharging, in accordance with an embodiment of the present disclosure.

FIG. 5 illustrates a schematic view of the system inside a tank holding a fluid, such as water, in accordance with another embodiment of the present disclosure.

FIG. 6 illustrates a schematic view of a system including multiple power rotors mounted on a lifting post, allowing substantially more energy to be stored within the same system with minimal incremental capital cost, in accordance with an embodiment of the present disclosure.

FIG. 7 illustrates a schematic/sectional view of the lifting post on which the power rotors are mounted, in accordance with an embodiment of the present disclosure.

FIG. 8 illustrates a top, sectional view of the lifting post including a rigid core, a rotator tube, and bearings, in accordance with an embodiment of the present disclosure.

FIG. 9 illustrates a schematic view of the rotator tube connected to a generator, in accordance with an embodiment of the present disclosure.

FIG. 10 illustrates a sectional view of a rotor hub assembly/power rotor, in accordance with an embodiment of the present disclosure.

FIG. 11(a) and FIG. 11(b) illustrate different views depicting rotor furling and unfurling mechanism, allowing the rotor to change its planform area inside the fluid medium relative to its direction of motion, in accordance with an embodiment of the present disclosure.

FIG. 11(c) and FIG. 11(d) illustrate simplified views of the rotor unfurled during charging, and furled during discharging, respectively, in accordance with an embodiment of the present disclosure.

FIG. 12(a) and FIG. 12(b) illustrate different views of a rotor retraction mechanism which allows rotor blades to change their exposed length, thereby changing the planform area of the rotor with respect to its direction of motion, in accordance with an embodiment of the present disclosure.

FIG. 13(a) illustrates a schematic representation of the fluid medium acting on the rotor blade to drive rotational motion of the rotor blades, in accordance with an embodiment of the present disclosure.

FIG. 13(b) and FIG. 13(c) illustrate different views of the rotor blade, in accordance with an embodiment of the present disclosure.

FIGS. 14(a) and 14(b) illustrate a schematic view and a perspective view, respectively, of fall breaking mechanisms, in accordance with an embodiment of the present disclosure.

FIGS. 15(a) and 15(b) illustrate schematic views and an isometric view, respectively, of a lifting assembly that lifts the power rotors for charging the system, in accordance with an embodiment of the present disclosure.

FIG. 16(a) and FIG. 16(b) illustrate a network architecture of the system, describing a flow of energy into and out of the system, from and to a grid, respectively, in accordance with an embodiment of the present disclosure.

### DETAILED DESCRIPTION

Before the present subject matter is described in detail, it is to be understood that this disclosure is not limited to the particular implementations described, as such may vary. It should also be understood that the terminology used herein is to describing particular implementations only, and is not intended to be limiting, since the scope of the present disclosure will be limited only by the appended claims. While this disclosure is susceptible to different implementations in different forms, there is shown in the drawings, and is described in detail herein, a preferred implementation of the disclosure with the understanding that the present disclosure is to be considered as an exemplification of the principles of the disclosure and is not intended to limit the broad aspect of the disclosure to the implementation illustrated. All features, elements, components, functions, and steps described with respect to any implementation provided herein are intended to be freely combinable and substitutable with those from any other implementation unless otherwise stated. Therefore, it should be understood that what is illustrated and described is set forth only for the purposes of example and should not be taken as a limitation on the scope of the present disclosure.

In the following description and in the figures, like elements are identified with like reference numerals. The use of “e.g.,” “etc.,” “or,” and “the like” indicates non-exclusive alternatives without limitation, unless otherwise noted. The use of “having,” “comprising,” “including,” or “includes” means “including, but not limited to,” or “includes, but not limited to,” unless otherwise noted.

Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising,” or “including” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like as would be expected by a person of ordinary skill in the art, but that do not appreciably affect overall performance.

As used herein, “about” means approximately or nearly, and in the context of a numerical value or range set forth means ±10% of the numeric value.

Throughout the present disclosure, “attachment means” include, but are not limited to, screws, nails, rivets, adhesives, magnets, hook and loop fasteners, hook and slot fasteners, interlocking elements, friction-grip releasable fasteners, fastening straps, and the like.

Currently, grid-level energy storage systems play a pivotal role in energy arbitrage, frequency regulation, and load leveling, but are limited by energy capacity, number of charge-discharge cycles, degradation over time, environmental impact, and so on. There is, therefore, a significant need for advancements in the energy storage technology that can bridge a gap between availability of renewable energy and a constant demand across the grid, facilitating a more resilient, reliable, and sustainable energy landscape.

The present disclosure relates to a grid-level energy storage and retrieval system designed for long-duration storage applications. The present disclosure aims to overcome the limitations of existing technologies by offering a solution that is not only more efficient and cost-effective, but also environmentally sustainable, thereby supporting a broader integration of renewable energy sources into the grid and enhancing the overall stability and reliability of an energy supply system. The present disclosure provides a means to store energy from the grid in the form of potential energy by lifting or moving one or more power rotors on between a first end and a second end of a lifting post against a resistive force (such as force of gravity and/or an elastic resistance mechanism). The resistive force biases the power rotors to move towards the first end of the lifting post. The power rotors may be positionally locked on the lifting post to retain the potential energy once moved away from the first end (or towards the second end), which prevents self-discharge and consequently minimizes energy losses. Further, the stored potential energy is readily convertible back into electrical energy or rotational motion by causing the power rotors to rotate (by interaction of rotor blades extending from the power rotors with a fluid medium) as the resistive force, which allows for nearly 100% depth of discharge. Further, the system of the present disclosure provides a significantly greater number of charge-discharge cycles in comparison to existing solutions, with nearly 100% round trip efficiency. The system of the present disclosure is also highly scalable due to its low cost and simple construction, and environment friendly as no toxic substances are required for construction and/or operation thereof.

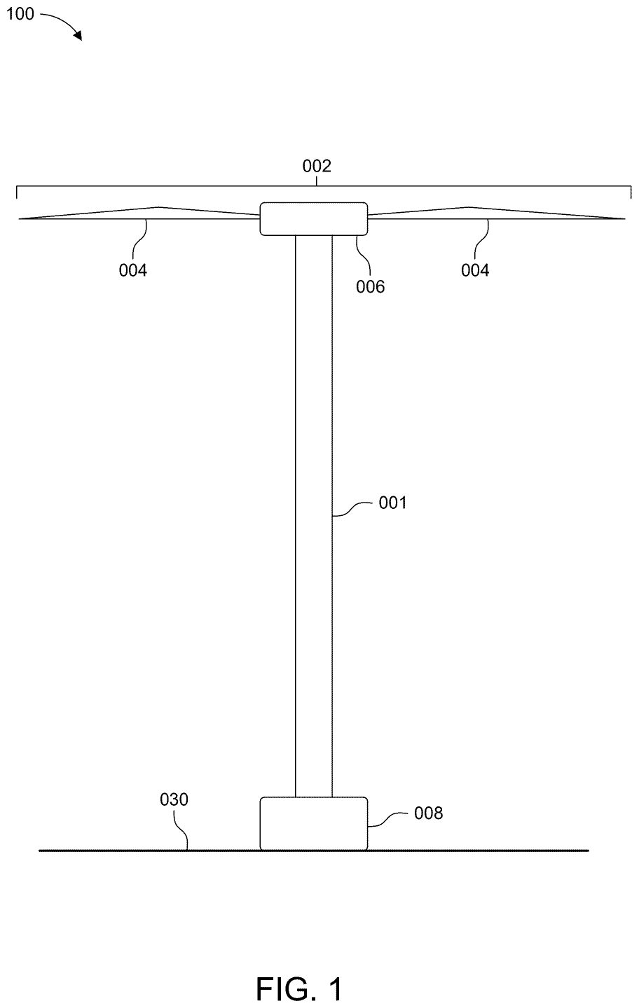

Various embodiments of the present disclosure will be explained in detail with reference to FIGS. 1-16(b).

FIG. 1 illustrates a schematic view of components and assembly of an energy storage and retrieval system (referred to as a system 100 hereafter), in accordance with an embodiment of the present disclosure.

With reference to FIG. 1, the system 100 may include a lifting post 001, and one or more power rotors (such as power rotor 002) movably connected to the lifting post 001. The power rotors 002 may be movable between a first end and a second end of the lifting post 001. In some embodiments, a resistive force may act on the power rotor 002, which biases the power rotor 002 to move towards the first end of the lifting post 001. The lifting post 001 may also include a cushioning or fall-breaking system 008 at the first end of the lifting post 001. The power rotor 002 may include a hub 006, one or more blades 004, and other elements described below. The lifting post 001 may be placed/supported on the ground 030 or any other rigid structure.

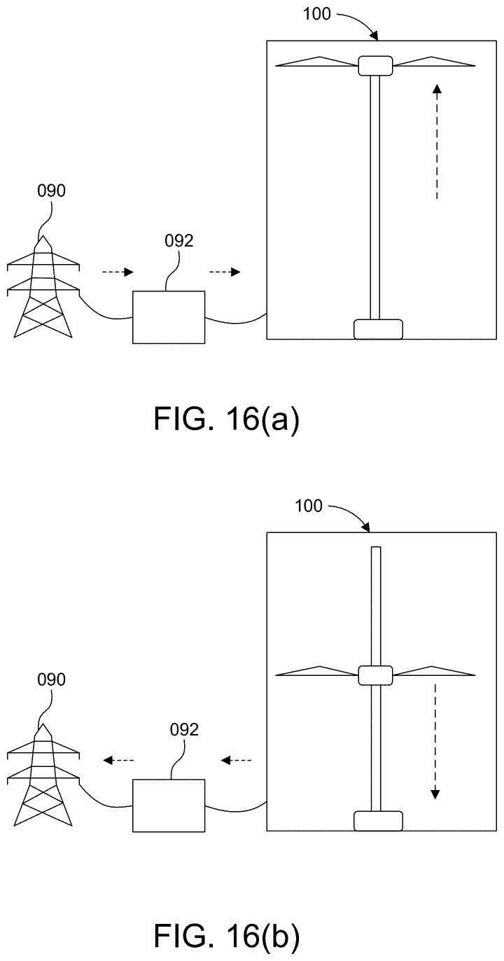

To store energy (such as electrical energy from a grid) in the system 100 (i.e., charge up), the power rotor 002 may be lifted/moved along a height/length (i.e., moved away from the first end) of the lifting post 001 against the resistive force, and positionally locked at a position along the height/length on the lifting post 001. In some embodiments, the power rotor 002 may be lifted from the bottom (i.e., the first end) to the top (i.e., the second end) of the lifting post 001 against the force of gravity, and positionally locked at the second end or any other position on the lifting post 001 based on the amount of energy provided to the system 100. In such embodiments, the power rotor 002 stores the (electrical) energy provided to the system 100 (such as from the grid as shown in FIG. 16(a)) in the form of potential energy.

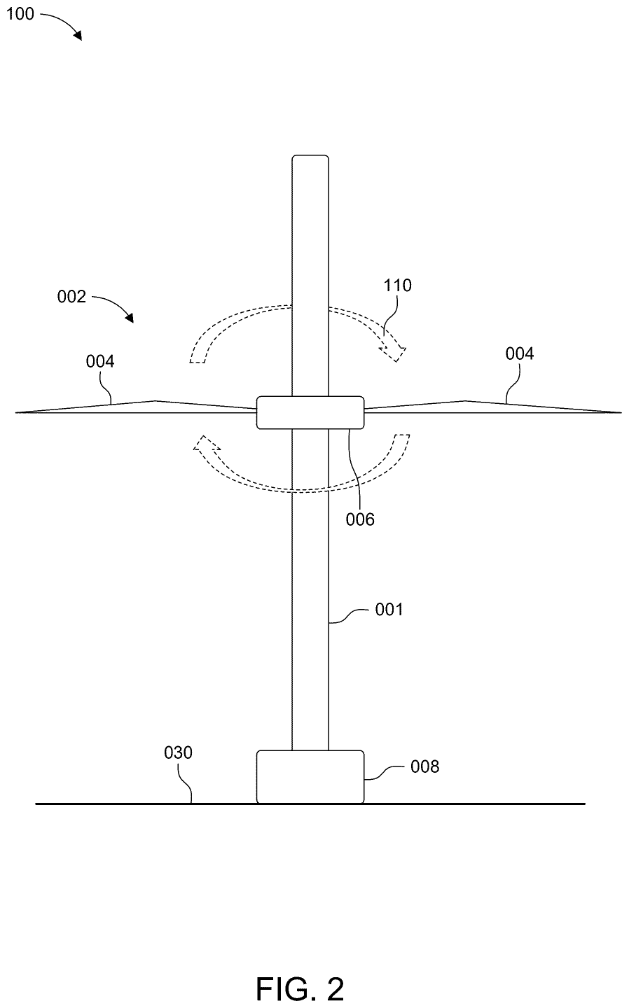

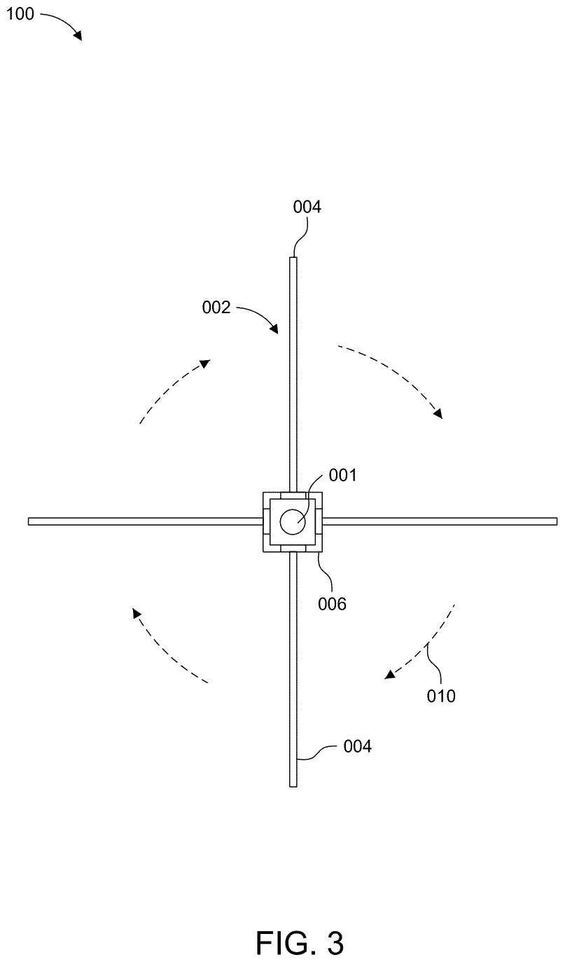

When the energy needs to be drawn out of or retrieved from the system 100 (i.e., discharge), the power rotor 002 may be released and allowed to fall (or is moved from the second end or the locked position towards the first end) under either the force of gravity, or another potential energy storage/elastic resistance mechanism that enables storage of potential energy in mechanical form. As the power rotor 002 falls or is moved, a fluid medium (such as air or water, or any other Newtonian fluid) surrounding the power rotors 002 acts on or interacts with the rotor blades 004, thereby producing two forces (namely a drag force and a lift force) on the rotor blades 004. The drag force may slow down a descent of the power rotor 002, converting a portion of the kinetic energy of the power rotor 002 into heat, which may be dissipated into the surrounding fluid medium. The lift force, on the other hand, may cause the power rotor 002 to rotate (as shown and described in reference to FIGS. 2 and 3), in a plane perpendicular to the direction of gravitational force (or resistance force of the spring-actuated mechanism).

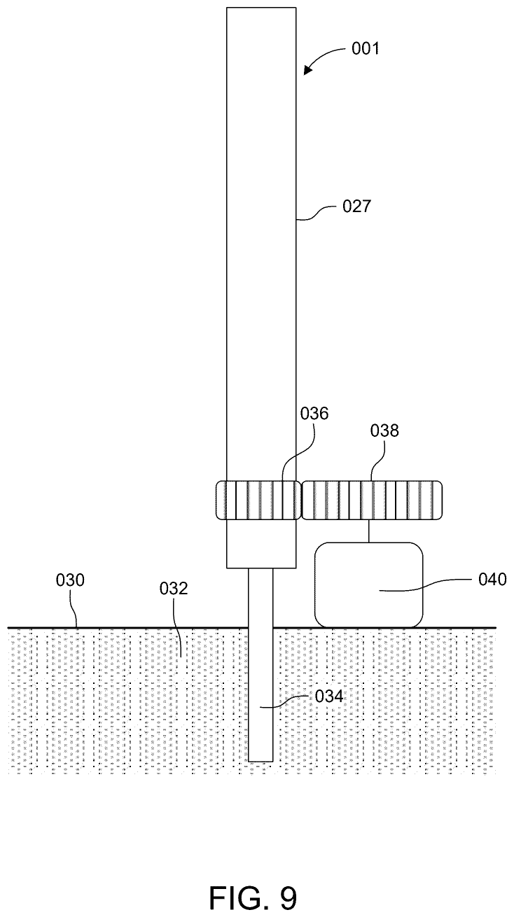

In some embodiments, the force generated by the rotation of the power rotor 002, as induced by the fluid medium, may be converted to electric power/energy through a generator (such as a dynamo shown in FIG. 9) functionally connected to the system 100. In some embodiments, the electric power/energy generated by the system 100 may be returned to the grid (as shown in FIG. 16(b)). In other embodiments, the rotation of the power rotors 002 may be used to drive another mechanical load. In such embodiments, the mechanical load may be rotationally locked with the power rotors 002 through the lifting post 001. Eventually, the power rotor 002 may reach the first end/bottom and may be fully discharged. In such cases, the power rotor 002 may be ready to charge once again. However, it is not necessary for the power rotor 002 to be at the first end for the system 100 to be ready for charging, and the system 100 may be charged when the power rotor 002 is at any position along the height/length of the lifting post 002 aside from the second end. The FIG. 1 shows the general components of the system 100 and their inter-relation. The details of each of the components are provided below.

FIG. 2 illustrates a schematic view depicting an operation of the system 100, where the power rotor 002 that stores energy is discharging, and is carrying out rotational motion in a process to release the stored energy, in accordance with an embodiment of the present disclosure.

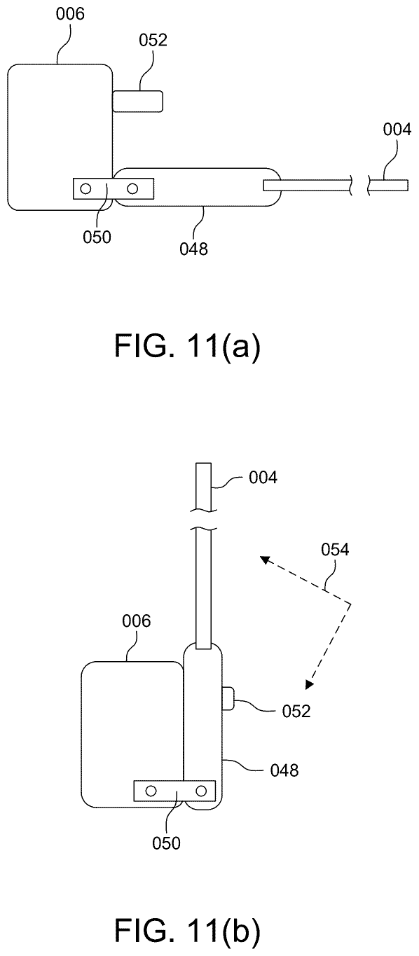

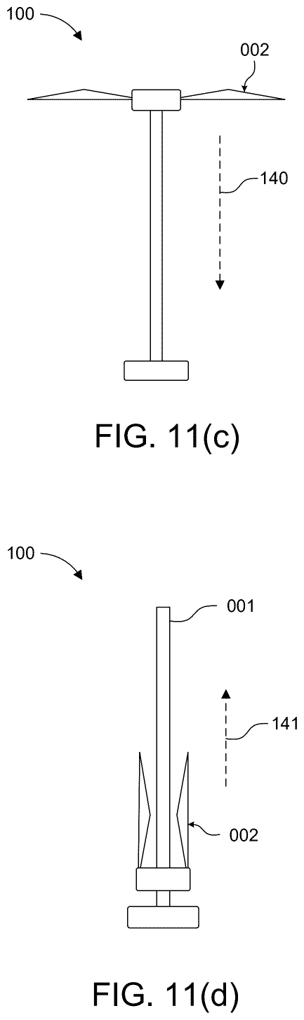

As shown in FIG. 2, arrow 110 indicates one possible direction of rotation of the rotor blades 004. The rotor blades 004 may be rotated in a plane perpendicular to the direction of the resistive force (such as gravitational force). The direction of rotation may be clockwise or anti-clockwise, when viewed from the ground 030, depending on the design of the rotor blades 004. An angular velocity of the power rotors 002 may vary based on a design chosen, the blade radius, and the height from which the power rotors 002 fall. Additionally, the angular velocity may also vary at different points during the fall of the power rotors 002 from the charged position to the discharged position. The design specifications of the power rotors 002 may be suitably adapted to obtain the desired angular velocity. The design specifications may be optimized with an objective to maximize energy conversion from kinetic energy to electrical energy. Aspects of the power rotors 002 are described subsequently in reference to FIGS. 11(a) to 13(c).

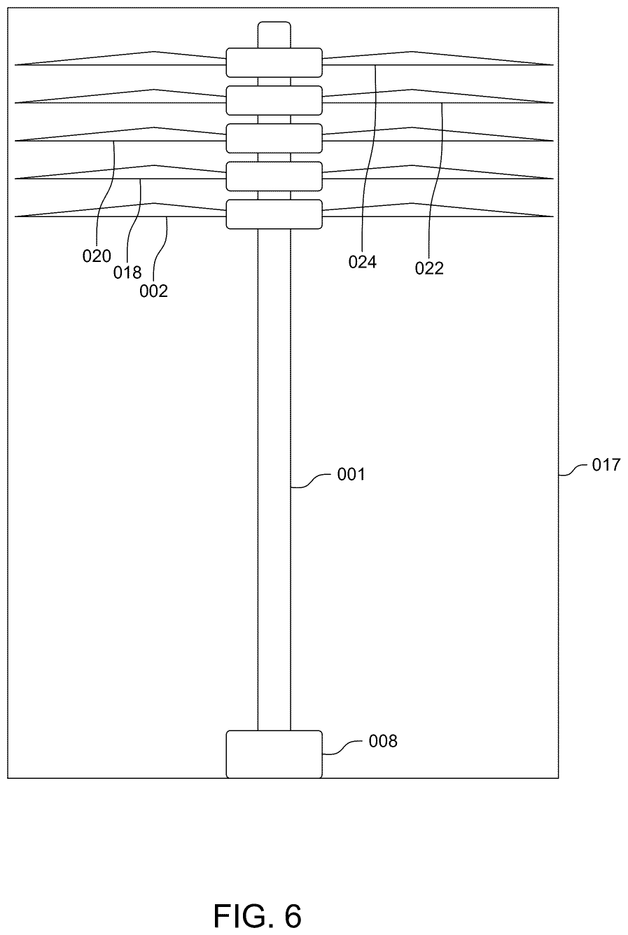

FIG. 3 illustrates a top view depicting a motion of the power rotor 002 under an influence of the fluid medium, as the stored energy is discharged, in accordance with an embodiment of the present disclosure. The arrows 010 show the direction of rotation of the power rotors 002. Although, four rotor blades 004 on the power rotor 002 are presented in FIG. 3, in other embodiments, a different number of rotor blades 004 may be used. Also, in the provided FIG. 3, the power rotor 002 rotates clockwise, however the rotor blades 004 can also be designed to rotate counter-clockwise. When multiple power rotors 002 are stacked together (as shown in FIG. 6), alternating power rotors 002 may be configured to rotate in an opposing direction, or the same direction.

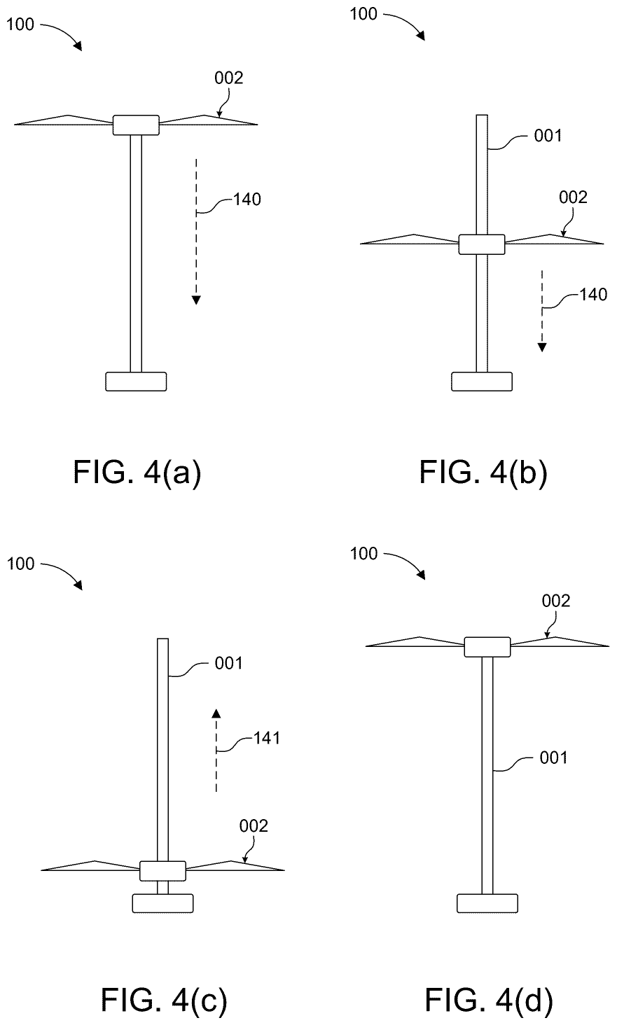

FIG. 4(a) to FIG. 4(d) illustrate schematic views depicting the operation of the system 100 in different stages of charging and discharging, in accordance with an embodiment of the present disclosure. The FIGS. 4(a) to 4(d) illustrate the charge-discharge cycle of the system 100. In FIG. 4(a), the power rotor 002 may be storing potential energy therein, as the power rotor 002 may be positioned at the second end of the lifting post 001 against the bias of the resistive force. It may be appreciated that the power rotor 002 may also be locked at any other position on the lifting post 001, where a different amount of potential energy may be stored therein in comparison to the amount of potential energy when the power rotor 002 is locked at the second end. The power rotor 002 may be released/unlocked to allow the resistive force to act on the power rotor 002, and move the power rotor 002 towards the first end of the lifting post 001. As the power rotor 002 starts to drop/move, in a direction indicated as 140, from the second end or any other position on the lifting post 001, the potential energy may be discharged.

In FIG. 4(b), the power rotor 002 has dropped partly and is in the process of discharging the energy, in the direction indicated as 140. The level of charge of the system 100 may be indicated by distance of the power rotor 002 from the first end. As the power rotor 002 is substantially in the middle of the lifting post 001 in FIG. 4(b), the energy stored in the system 100 may be substantially half of a storage capacity of the system 100. In some embodiments, the system 100 may be partially discharged, and allowed to retain the remaining energy after the partial discharge. In such embodiments, the power rotor 002 may be locked (such as at the position shown in FIG. 4(b)) once the desired amount of energy has been extracted from the system 100. The discharged energy may be either converted to electrical energy, or used to drive the mechanical load.

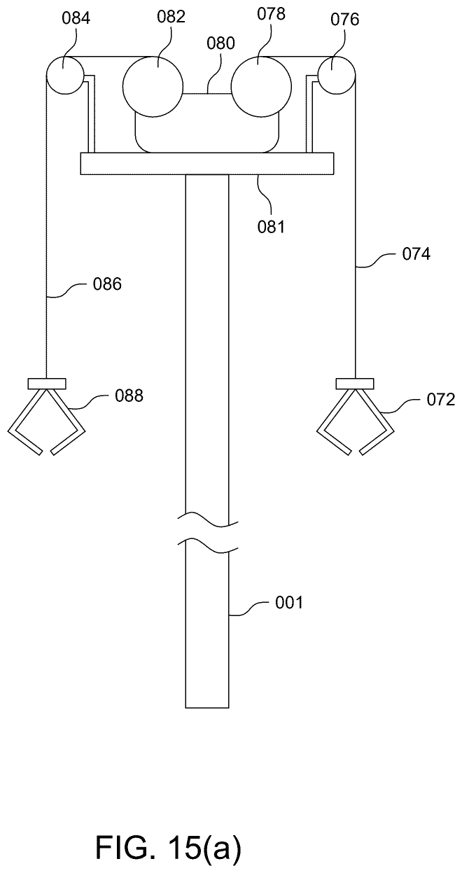

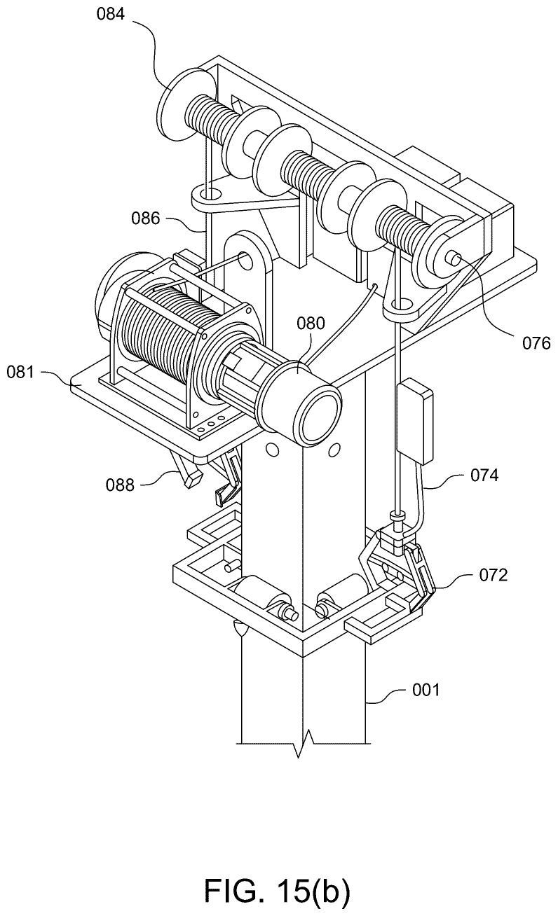

In FIG. 4(c), the power rotor 002 has reached the first end/bottom and is now fully discharged and in the process of being lifted back up (or moved away from the first end towards the second end) against the resistive force to recharge (i.e., in a direction indicated as 141). In some embodiments, the power rotor 002 may also be lifted or moved away from the first end from the position shown in FIG. 4(b), in case the system 100 is partially charged at the time of recharging. The power rotor 002 may be lifted/moved against the resistive force by a lifting mechanism, such as those shown in FIGS. 15(a) and 15(b). In FIG. 4(d), the power rotor 002 is returned to the second end/top, and is now again storing energy. To allow the system 100 to retain the energy provided thereto, the power rotor 002 may be locked at the second end (or at any other position based on amount of energy to be stored). As stated, the power rotor 002 may be lifted against the force of gravity and/or elastic resistance mechanism (not shown). In some embodiments, the elastic resistance mechanism may be an elastic element/component attached to the first end and the power rotors 002. The resilient element/component may store potential energy when the resilient element/component is deformed (such as a spring of a spring-actuated mechanism reversibly stretching or lengthening) by the movement of the power rotor 002 away from the first end. In such embodiments, the lifting post 001 may be positioned at any angle with respect to the ground (such as parallelly or perpendicularly).

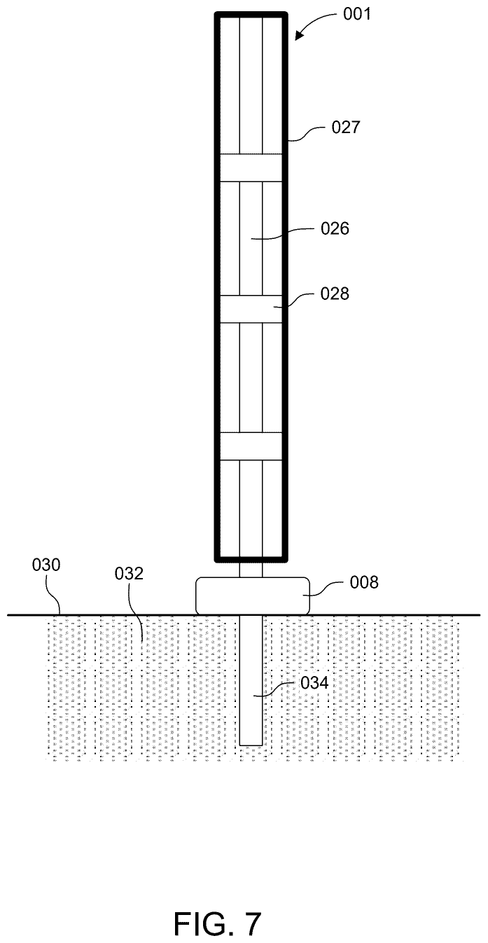

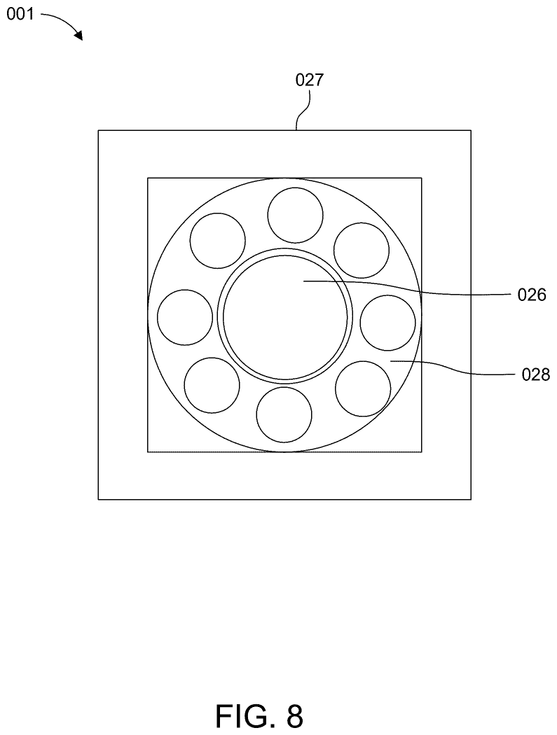

Since the system 100 stores energy as potential energy, there is no self-discharge, thereby allowing the stored energy to be retained perfectly. Further, since there is no self-discharge, the stored energy can be retained for extremely long periods without any losses. Additionally, the storing energy as potential energy, and retrieving the stored energy through conversion of the potential energy into kinetic energy (and subsequently into electrical energy), the system 100 may provide nearly 100% depth of discharge on each cycle without any degradation of performance, and also provide a significant number of charge-discharge cycles, likely in the millions. Also, the storage and retrieval mechanism of the system 100 allows for possibly over 90% round-trip efficiency, as described further in reference to FIGS. 7 to 10.

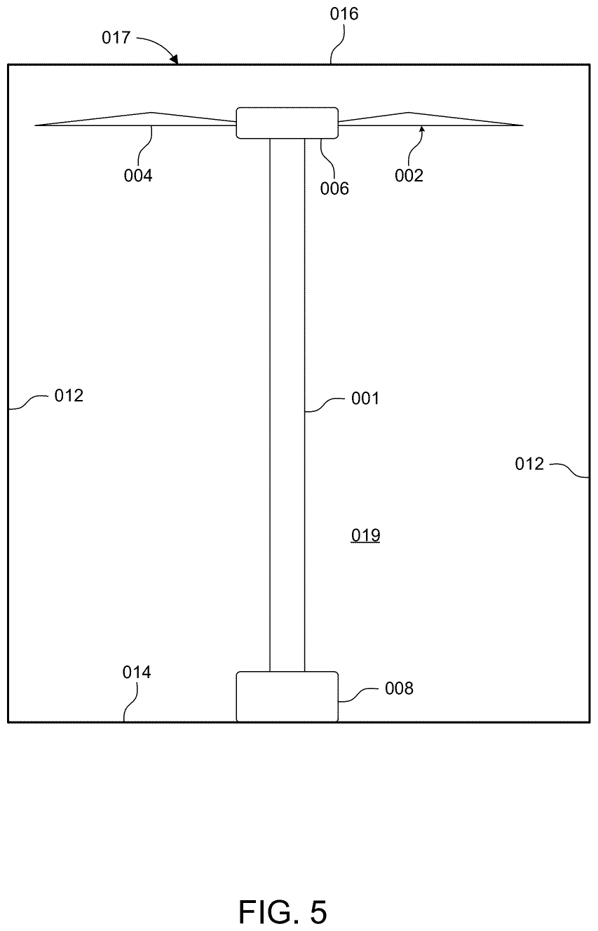

In some embodiments, the system 100 may be placed in an open-air environment, where the fluid medium interfacing with the rotor blades 004 is air. In such embodiments, the lifting post 001 may be directly mounted on the ground 030, or any other rigid structure (such as a concrete foundation). In other embodiments, the system 100 may be implemented in any other open environment, such as underwater locations. In further embodiments, the system 100 may be implemented in a tank having other fluid mediums, as shown in FIG. 5. The ability to install the system 100 at any location promotes scalability, by allowing the system 100 to be placed at any geographical location.

FIG. 5 illustrates a schematic view of the system 100 inside a tank 017 holding a fluid in liquid state, in accordance with another embodiment of the present disclosure. In some embodiments, the tank 017 may be built around the system 100 to hold the fluid medium (i.e., tank fluid 019). The tank fluid 019 may be, for example, but not limited to, water. The tank 017 may include a tank base 014, tank side walls 012, and a tank roof 016. The tank 017 depicted in FIG. 5 is symmetrical, where the tank side wall 012 wraps around the tank 017. However, it may be appreciated that the tank 017 may have any suitable geometric profile configured to allow the power rotor 002 to move between the first end and the second end of the lifting post 001.

In some embodiments, the tank roof 016 may be omitted. The tank 017 may be filled with water, thereby providing a much higher density fluid for applying torque on the power rotor 002, in comparison. Other fluids having the desired density may be selected based on requirements and/or constraints of the use case (such as design specifications of the power rotors 002). Further, in some embodiments, if the tank fluid 019 is a conductive medium such as water, some electrical machinery such as the lifting mechanism and the generator may be placed outside the tank 017 or placed in fluid-proof/waterproof enclosures within the tank 017. Before operating the system 100 for storing energy, the tank 017 may be filled with water. The process of storing or discharging energy in the system 100 may not consume the water, though some water may be lost over time due to evaporation if the tank roof 016 is not placed. The use of water as working fluid/fluid medium may impact a selection of the rotor blade design and other design criteria such as height and radius of the system 100. However, an overall operating model stays the same irrespective of the selection of the working fluid. The tank 017 may be formed of cylindrical or any other shape, however, the cylindrical shape may be generally considered optimal.

FIG. 6 illustrates a schematic view of the system 100 including multiple ones of the power rotor 002 mounted on the same lifting post 001, in accordance with an embodiment of the present disclosure.

With reference to FIG. 6, multiple power rotors may be mounted on the same lifting post 001 and/or placed in the tank 017. By mounting multiple power rotors mounted on the same lifting post 001, substantially more energy may be stored within the same system 100 with minimal incremental capital cost. In addition to the (first) power rotor 002, additional power rotors 018, 020, 022, and 024 may be stacked on the lifting post 001, as illustrated in FIG. 6. Each power rotor 002, 018, 020, 022, and 024 may include corresponding blades, hubs, and additional mechanisms, independent of other power rotors. The power rotor design may be optimized such that a vertical thickness of each power rotors 002, 018, 020, 022, and 024 may be extremely low, relative to the height/length of the lifting post 001. Additionally, the rotors 002, 018, 020, 022 and 024 may be designed to stack over each other in such a way that they occupy minimal vertical space. To charge up, each power rotor may be lifted/moved towards the second end of the lifting post 001. In some embodiments, once the power rotors 002, 018, 020, 022 and 024 are stacked, they may be released sequentially to regenerate the energy for use by an external load or to return the electrical energy to the grid. In some embodiments, a second power rotor may be released for discharge while the previous power rotor is still dropping and is in the process of discharging. In such embodiments, each of the power rotors may be released once a distance between consecutive power rotors is greater than a predetermined threshold. In further embodiments, two or more power rotors may also be released simultaneously to increase the power output (i.e., the energy being discharged) from the system 100. In various embodiments, the number of rotors stacked on a single lifting post may be, for example, over a thousand.

FIG. 7 illustrates a schematic/sectional view of the lifting post 001 on which the power rotor 002 (and also power rotors 018, 020, 022 and 024) is mounted, in accordance with an embodiment of the present disclosure.

With reference to FIG. 7, the lifting post 001 may include a rigid core 026, a rotator tube 027, bearings 028, and the cushioning or fall-breaking system 008. In some embodiments, the rigid core 026 may be a solid shaft made of a high tensile strength material such as, for example, steel. The shaft may be lowered into the soil under the ground 030, and held in place within a concrete foundation 032. An underground section 034 of the rigid core 026 may be placed in the concrete foundation 032. The rigid core 026 may provide structural support to hold the rest of the system 100 in place. The rotator tube 027 may be mounted on the rigid core 026 via one or more of the bearings 028. In some embodiments, the bearings 028 may be standard ball bearings, or other types of bearings such as magnetic bearings, roller bearings, lubricated plain bearings, and the like, but not limited thereto. The bearings 028 may allow the rotator tube 027 to spin around/rotate about the rigid core 026 freely. The bearings 028 may be mounted along the length of the rigid core 026, at any appropriate spacing.

FIG. 8 illustrates a top, sectional view of the lifting post 001 including the rigid core 026, the rotator tube 027, and the bearings 028, in accordance with an embodiment of the present disclosure.

With reference to FIG. 8, the rigid core 026 may be a solid rod with a circular cross-sectional contour. The bearings 028 may be mounted on the rigid core 026 to allow free rotation of the rotator tube 027 around the rigid core 026. The rotator tube 027 may be then mounted on the bearings 028. In some embodiments, an inner ring of the bearings 028 may be connected to the rigid core 026 and an outer ring of the bearings 028 may be connected to the rotator tube 027. The rotator tube 027 may have a non-circular cross-sectional contour, such as a square shape, triangular shape, pentagonal shape, or any other polygonal shape. The rotator tube 027 may be non-circular in order to allow torque to be applied on it by the power rotors 002. If the rotator tube 027 is circular, the power rotors 002 may be ineffective in transferring the torque to the rotator tube 027. In some embodiments, the rotator tube 027 may also be made with a high strength material such as steel.

FIG. 9 illustrates a schematic view of the rotator tube 027 connected to a generator, in accordance with an embodiment of the present disclosure. With reference to FIG. 9, the rotator tube 027, which is a part of the lifting post 001, may include a mechanical interface for connecting the rotator tube to the generator. In some embodiments, the mechanical interface may include a rotator tube gear 036 mounted on the rotator tube 027. The rotator tube gear 036 may be connected with interlocking gears 038, which drive the generator, such as a dynamo 040. In this manner the rotation of the rotator tube 027 may be transferred to the dynamo 040 to generate electric power.

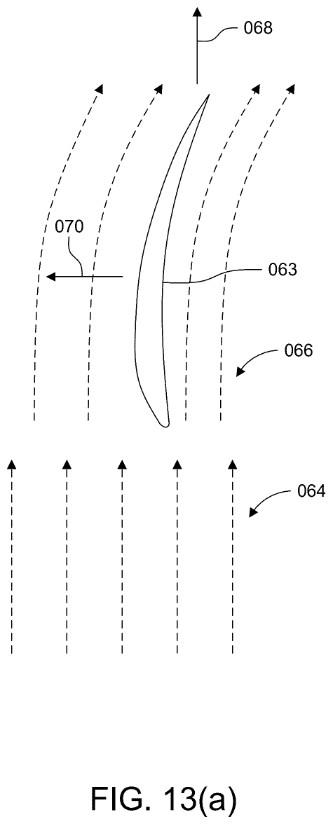

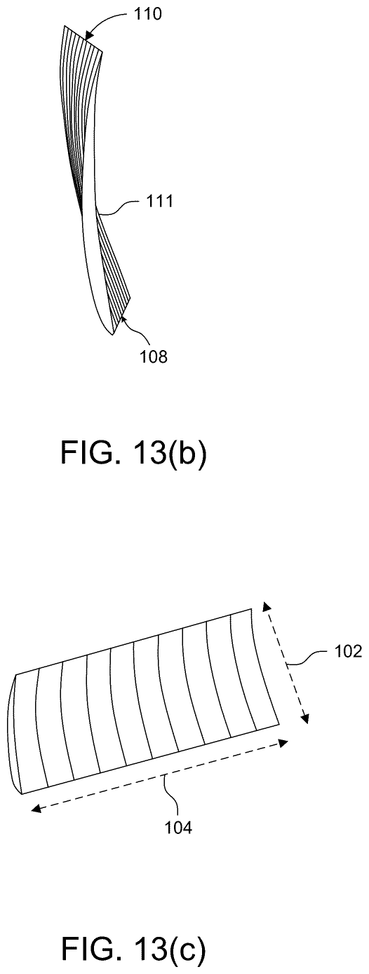

FIG. 9 depicts a highly simplified representation displaying only the critical components, and the mechanical interface may include additional gears between the rotator tube gear 036 and the interlocking gears 038. In further embodiments, the rotation of the rotator tube 027 may be provided to the dynamo 040 through a belt drive mechanism 039, as shown in FIG. 13(b). Also, in some embodiments, the mechanical power delivered by the rotator tube 027 may be used directly as mechanical power without conversion to electric power/energy.

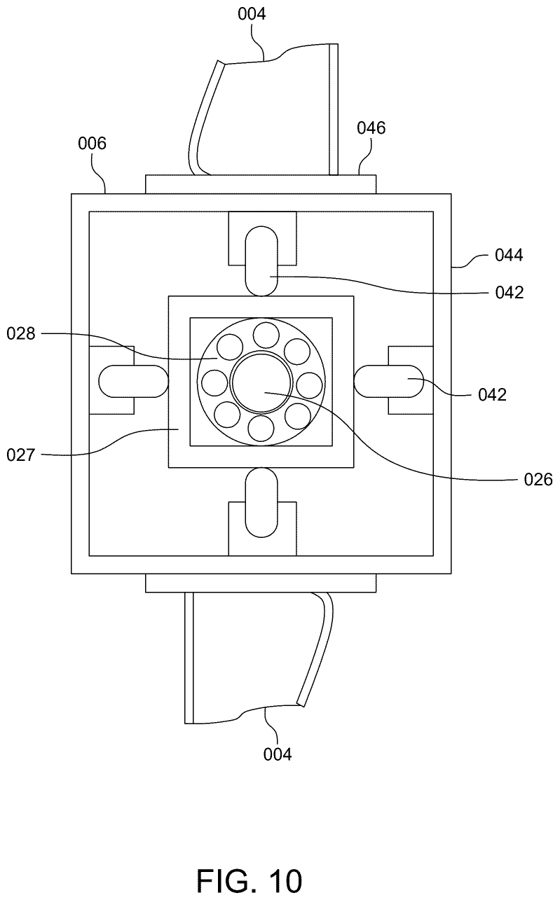

In some embodiments, the generator/dynamo 040 may be placed on the ground 030, i.e., closer to the first end of the lifting post 001. In other embodiments, the generator/dynamo 040 may be placed elsewhere, such as on or proximate to the second end of the lifting post 001. Additionally, it may be noted that there are other methods for generating power from rotational motion of the rotator tube 027. In FIG. 10, additional elements are shown, as described previously, such as the ground 030, the concrete foundation 032, and the rigid core underground section 034, in order to describe their position relative to the rotator tube 027 and the dynamo assembly.

FIG. 10 illustrates a sectional view of a rotor hub assembly/power rotor 002, which includes a rotor bracket 046, a hub ring 044, and hub sliding wheels 042, in accordance with an embodiment of the present disclosure. With reference to FIG. 10, the hub 006 of the power rotor 002 may allow the rotor blades 004 to simultaneously slide along the rotator tube 027, while transferring the torque induced by the rotation of the power rotors 002 to the rotator tube 027 during discharge. Though the hub 006 is represented as a square in FIG. 10, the hub 006 may be shaped in any other shape. The hub 006 may be made of a high strength material so that the hub 006 can sustain the weight of the rotors 002. In some embodiments, the hub 006 may also be made of non-buoyant materials that sink in the fluid medium under the influence of gravity (or any other resistive force). The rotor brackets 046 may enable attachment of the rotor blades 004 to the hub ring 044. The rotor bracket 046 is represented in a highly simplified form in FIG. 10, however, the rotor bracket 046 may also include sub-components within itself, as described below.

The hub sliding wheels 042 may be mounted on the hub ring 044 of the hub 006. In some embodiments, the hub sliding wheels 042 may be implemented as a wheel-and-axle mechanism. The hub sliding wheels 042 may slide along an outer surface of the rotator tube 027, allowing a low friction mechanism for the rotors 002 to slide along the length/height of the rotator tube 027. In some embodiments, the hub sliding wheels 042 may be configured to allow movement/sliding of the power rotor 002 along the height of the lifting post 001 or the rotator tube 027. Additionally, as the rotor blades 004 spin, the hub sliding wheels 042 may also transfer the torque from the rotor blades 004 to the rotator tube 027, thereby imparting rotational motion to the rotator tube 027. In such embodiments, the hub sliding wheels 042 may be connected to or interfaced with the rotator tube 027 such that the power rotor 002 and the rotator tube 027 are rotationally locked. Though four hub sliding wheels 042 are depicted in FIG. 10, any number of hub sliding wheels 042 may be used based on the requirement. Additionally, the hub sliding wheels 042 may be wider or narrower, or formed of different diameter, in different embodiments depending on the requirements. In some embodiments, the hub sliding wheels 042 may be connected to a motor, which may be configured to actuate the hub sliding wheels 042 to lift/move the power rotor 002 towards the second end to store energy, in addition or alternatively to the lifting mechanism described in reference to FIGS. 15(a) and 15(b). In such embodiments, the motor may be supplied power by grid.

In some embodiments, the rotor blades 004 may be furled and/or unfurled with respect to the hub 006 of the power rotor 002. FIG. 11(a) and FIG. 11(b) illustrate different views depicting furling and unfurling mechanism of the rotor blades 002, allowing the power rotor 002 to change its planform area inside the fluid medium relative to its direction of motion, in accordance with an embodiment of the present disclosure.

FIG. 11(a) depicts the rotor blade 004 mounted on a rotor base 048, which provides structural support to hold the rotor blade 004 in place. In some embodiments, the rotor blade 004 may be attached to the rotor base 048 through any attachment means. In other embodiments, the rotor blade 004 may integrally extend from the rotor base 048. The rotor base 048 may be mounted on the hub 006 via a rotor hinge 050. A stepper motor (not shown) may be placed in the rotor base 048, or the hub 006, which may turn the rotor base 048 and the rotor blade 004 up into the furled position (as shown in FIG. 11(b)), when the rotor blade 004 needs to be furled. A rotor lock 052 on the hub 006 may be activated to hold the rotor base 048 and the rotor blade 004 in place once furled. Arrow 054 shows the direction of furling and unfurling. It is to be noted that the rotor lock 052 may not be required in some embodiments and the stepper motor may itself hold the rotor blade 004, with the rotor base 048, in the furled position. In some embodiments, the angle of attack of the rotor blade 004, with respect to the fluid around may also be changed during the furling and unfurling action, to minimize drag. In some embodiments, the rotor blade 004 may be furled when the system 100 is being charged or potential energy is being stored, i.e., being lifting or moving the rotor blade 004 from the first end to the second end, as shown in FIG. 11(c). Furling the blades during charging may minimize the drag applied by the rotor blades 004 of the rotor 002, thereby minimizing energy losses during charging. The blades 004 may be unfurled (as shown in FIG. 11(a)) by operating the stepper motor in reverse, when discharging in order to enable the working fluid to act on the rotor blades 004 fully to regenerate/convert the stored potential energy as mechanical power (i.e., as rotational motion of the rotor 002), as shown in FIG. 11(d).

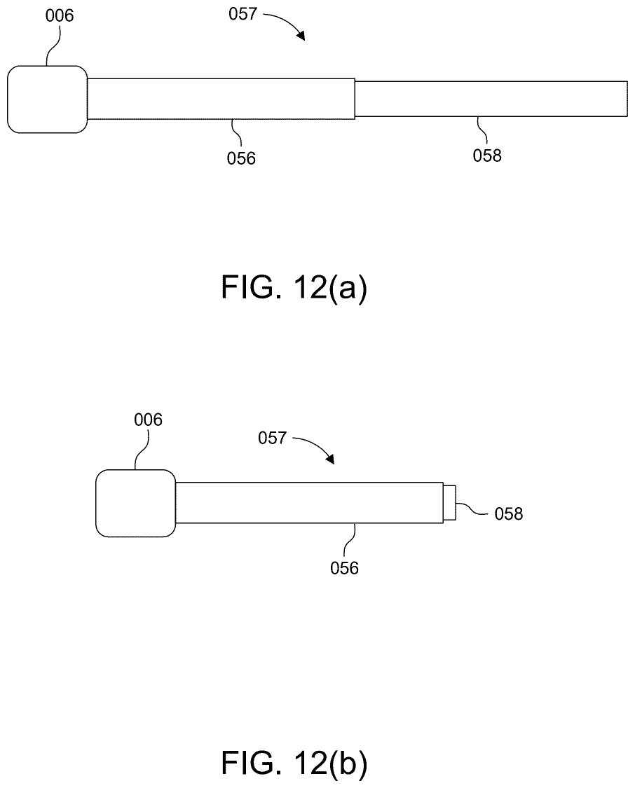

FIG. 12(a) and FIG. 12(b) illustrate different views of a rotor retraction mechanism which allows the rotor blades 004 to change their exposed length, thereby changing the planform area of the rotor 002 with respect to its direction of motion, in accordance with an embodiment of the present disclosure.

With reference to FIG. 12(a), the hub 006 may be connected with a telescoping rotor blade 057. The telescoping rotor blade 057 may be formed of two parts, namely, a telescoping rotor base portion 056 and a telescoping rotor extender portion 058. In the fully extended mode, shown in FIG. 12(a), the telescoping rotor extender portion 058 may be extended out to its maximum length outside the telescoping rotor base portion 056. In FIG. 12(b) the telescoping rotor extender portion 058 may be stowed within the telescoping rotor base portion 056, so that none or very small portion of the extender portion 058 is exposed to the fluid medium. Retracting a portion of the rotor blade 004 may reduce the time to lift/move the rotor blade 004 towards the second end for charging by reducing the drag force experienced by the rotor blades 004 in the fluid medium. The extension and retraction action may be driven by a small stepper motor placed within the telescoping rotor base portion 056, extender portion 058, and/or the hub 006. Additionally, the rotor blades 004 may be telescoping and/or furlable so that the rotor blades may be both retracted and furled when it is being lifted.

FIG. 13(a) illustrates a schematic representation of the fluid medium acting on the rotor blade 004 to drive rotational motion of the rotor blades 004, in accordance with an embodiment of the present disclosure.

With reference to FIG. 13(a), free stream flow streamlines 064 may reach a rotor foil 063 that defines the geometric profile of the rotor blades 004. As the free stream flow streamlines 064 pass over the rotor foil 063, the free stream flow streamlines 064 may be slightly bent by the fluid-body interaction, as depicted in the FIG. 13(a), by the rotor flow streamlines 066. This interaction of the fluid medium with the rotor foil 063 may create two forces on the rotor blade 004, namely, a drag force 068 and a lift force 070. The drag force 068 may cause the rotor 002 to slow down in its movement towards the first end. The drag force 068 also results in some of the kinetic energy of the dropping rotor to be dissipated into the fluid medium as heat. The lift force 070 may cause the rotor 002 to rotate around the lifting post 001. The lift force 070 may create a torque on the rotor blades 004 which drives the rotation of the power rotor 002, to drive the rotation of the rotator tube 027 and eventually generate power through the dynamo 040. Though the foil profile illustrated in FIG. 13(a) is only one possible profile, based on the Eppler 61 airfoil, other foil shapes are also possible. The angle of attack of the rotor foil 063 may have a significant impact on the relative size of the drag and lift forces. A low angle of attack, in general, may result in a substantially larger lift force than the drag force. One constraint on the operation of the system 100 may be a tip speed of the rotor blades 004. In general, horizontal axis turbines, as depicted in FIG. 13(a), may achieve maximum efficiency at a tip speed ratio of 4:10. The system 100 may be designed to operate with an angular velocity that achieves an optimal tip speed ratio. Additionally, when the blade length is high, it is important to ensure the absolute tip speed is not too high, as it may result in cavitation when the fluid medium is dense, like water. In case the fluid medium is air, the rotor blade 004 may be designed such that the tip speed is below the local speed of sound in air to ensure subsonic operation. In addition, long blades may face substantial mechanical stresses from cantilever force and from the centrifugal forces when spinning. Using sufficiently strong materials and limiting the angular velocity, the mechanical stresses on the rotor blades 004 may be reduced. When using water as the fluid medium, the buoyant force of the water may help counteract some of the mechanical stress on the rotor blades 004.

FIG. 13(b) and FIG. 13(c) illustrate different views of the rotor blade 004, in

accordance with an embodiment of the present disclosure.

FIG. 13(b) depicts a side view of the rotor blade 004, showing its shape, twist, and profile, while FIG. 13(c) depicts a front view of the rotor blade 004. FIG. 13(b) depicts a leading edge 108, a trailing edge 110, and an airfoil profile 111 of the rotor blade 004. The fluid medium (such as air or water) may be allowed to pass through the rotor blade 004 along its length/span, from the leading edge 108 to the trailing edge 110, thereby generating drag and lift forces. FIG. 13(c) depicts the frontal profile, where a width and the length 104 of the blade 102 are shown. The design of the rotor blade 004 shown is one embodiment of many possible rotor blade designs. The rotor blades 004 may be varied in airfoil selection, length, width, thickness and angle of attack, and the twist angles along the length.

The total power stored in the system 100 may be strongly determined by the terminal velocity of the power rotor 002, which is the velocity of fall at which the gravitational, buoyant, and drag forces balance each other to set the fall velocity at a fixed magnitude. Too low terminal velocity may limit power output, and too high terminal velocity may cause dynamic problems such as excessively high tip speeds. The design specifications of the power rotors 002 (and/or the rotor blades 004 thereof) may be suitably adapted to have the optimal terminal velocity according to the requirements of the use case.

When the power rotor 002 drops or moves towards the first end, it may sometimes spin opposite to the intended direction of rotation, due to local pressure variations. If the direction of rotation is opposite to the direction of torque on the rotor blades 004, then no work can be done and energy cannot be recovered. However, as long as the direction of rotation is same as the direction of torque, even if its opposite of the initial and intended direction, work can be done and energy generated.

The design of the hub 006 depicted in the present disclosure does not factor in the drag induced by the hub 006. In general, the drag from the hub 006 may be minimal relative to the rotor blades 004, but nevertheless, the hub 006 may also be designed to be streamlined to minimize the drag.

The angle of attack of the rotor blades 004 may also be adjusted dynamically during the movement of the power rotors 002 to the first end. This can be done to: (a) reach optimal drop speed, (b) adjust angular velocity, (c) prevent, overcome, or mitigate formation of problematic fluid flow formations around the rotor blades 004. The rotor blades 004 may be optimized to efficiently enable the system 100 to extract rotational energy from the potential energy of the power rotors 002, thereby ensuring that the energy added to the system 100 (by moving the power rotors 002 away from the first end against the resistive force) is substantially equal to the energy released by the system 100 (by causing the power rotors 002 to rotate the rotator tube 027 when the rotor blades 002 interact with the fluid medium as the resistive force moves the power rotors 002 towards the first end).

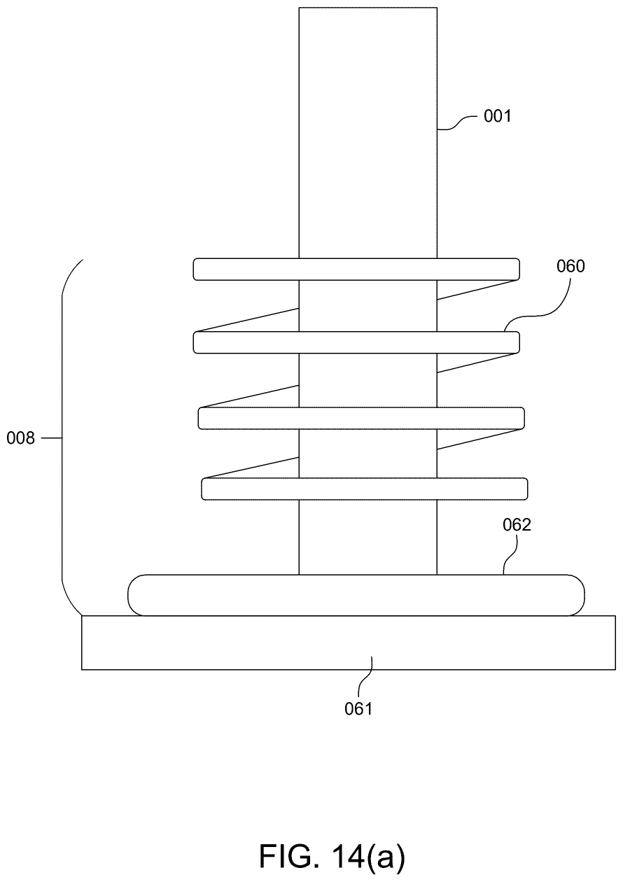

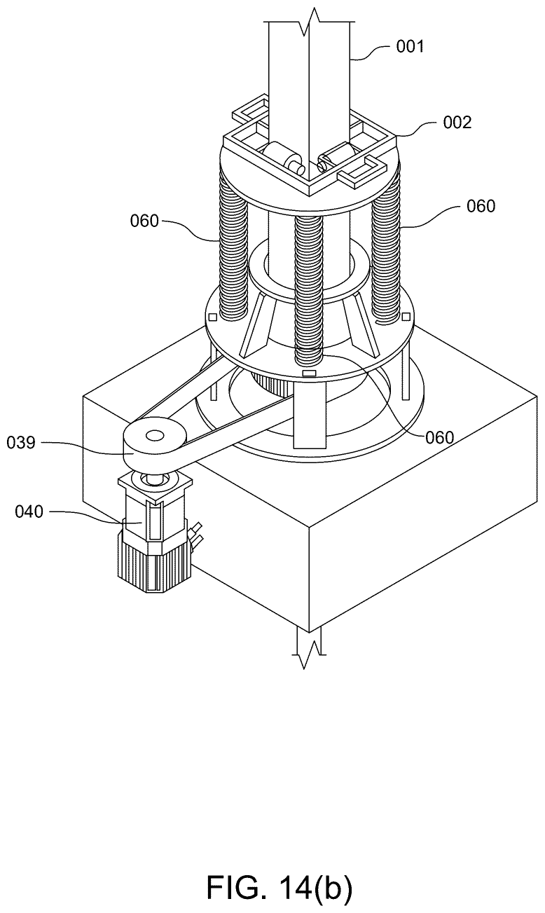

FIGS. 14(a) and 14(b) illustrate a schematic view and a perspective view, respectively, of the cushioning or the fall-breaking mechanism 008, in accordance with an embodiment of the present disclosure. The cushioning/fall-breaking mechanism 008 may include a fall-breaker spring 060 and/or a catching cushion 062.

With reference to FIG. 14(a), the fall-breaker spring 060 may be placed around the lifting post 001. In some embodiments, the fall breaker spring 060 may be placed at the first end of the lifting post 001. When the power rotor 002 is dropping/falling or is moving towards the first end, the rotor 002 needs to be slowed down and brought to rest gradually. The fall-breaker spring 060 may catch the moving power rotor 002 and slow it down, releasing the kinetic energy of the power rotor 002 as spring action, thereby enabling the power rotor 002 to come to rest gradually and without damage, near the ground 030 or towards the first end of the lifting post 001. In some embodiments, the catching cushion 062 may be a disc made of a cushioning/resilient material (such as rubber or any other elastomer material) placed on a post base 061. The catching cushion 062 may prevent direct contact between the rotor blades 004 and the ground 030, and provide additional protection.

In some embodiments, the catching cushion 062 may be provided in addition to the fall-breaker spring 060. In other embodiments, the catching cushion 062 may be provided without the fall-breaker spring 060. The hub 006 of the power rotor 002 may be designed to come in contact with the fall-breaker spring 060 and the catching cushion 062 to bring the rotor 002 to a stop gradually. The hub 006 may have additional components that engage with the fall-breaker spring 060. In one embodiment, when multiple power rotors are stacked on the lifting post 001, the fall-breaker spring 060 and the catching cushion 062 may be integrated into the hub 006 of each power rotor, such that each power rotors can stop itself by gradually coming in contact with the fall-breaker spring 060 and the catching cushion 062 of the power rotor below it.

While the aforementioned description provides some embodiments of a mechanism to bring the falling power rotor 002 to rest gradually and without damage, other similar embodiments using well known techniques for cushioning impact may be used. For instance, as shown in FIG. 14(b), multiple fall-breaker springs 060 (such as the three fall-breaker springs 060, and a fourth fall-breaker springs hidden behind the lifting post 001) may be used to cushion the fall/movement of the power rotor 002. While four fall-breaker springs 060 are provided in the embodiment shown in FIG. 14(b), it may be appreciated that any number of fall-breaker springs 060 may be implemented to cushion the power rotor 002 during discharge.

FIGS. 15(a) and 15(b) illustrate a schematic view and a perspective view of a lifting mechanism that lifts the power rotors 002 for charging the system 100, in accordance with an embodiment of the present disclosure.

With reference to FIGS. 15(a) and 15(b), the lifting assembly may include a winch 080, winch cables 074 and 086, pulleys 076 and 084, mechanical grabbers 072 and 088, and cable spools 078 and 082. Additionally, the lifting assembly may include control systems (not shown). The winch 080 may be placed on a winch platform 081 at the top/second end of the lifting post 001. The winch 080 may be configured to operably extend and/or retract the mechanical grabbers 072, 088 by unspooling and spooling the corresponding cable spools 078, 082, respectively. To lift the power rotors 002, the winch 080 may unspool and lower the mechanical grabbers 072 and 088 down to the position of the power rotor 002. The rotor hub 006 (or any other component of the power rotor 002) may have grabbing handles (not shown) extending therefrom. The mechanical grabbers 072, 088 may hold the grabbing handles on the hub 006. Once the mechanical grabbers 072 and 088 are engaged with the corresponding grabbing handles on the hub 006, the winch 080 may start winding, thereby pulling up the cables 074 and 086, to lift the power rotor 002 to the top/second end or to any position on the lifting post 001. The power rotor 002 may be lifted for charging or storing energy into the system 100. Once the power rotor 002 reaches its intended position, the power rotor 002 may be locked in place through a locking mechanism (not shown). In case multiple power rotors are on the same lifting post 001, various methods may be used to lift them individually using the same lifting mechanism. One such method is to have the hub 006 of each power rotor at slightly different sizes and use adjustable pulley positions to move winch cables 074, 086 and grabbers 072, 088 to the right position. Alternatively, a different mechanism may be used to lift the power rotors 002 back to the second end. One such mechanism is to directly power the hub sliding wheels 042 on the hub 006 so as to drive the hub 006 and the power rotor 002 to the predefined position against gravity over the lifting post 001 or the rotator tube 027, which requires adding sufficient friction between the sliding wheels 042 and the rotator tube 027 to enable the hub sliding wheels 042 to drive the power rotor up. Other mechanisms may also be applicable such as electromagnetic drives such as Maglev to lift the power rotors 002 to the intended position. When the power rotor 002 is being lifted up to the predefined position or the second end, the rotor blades 004 may be furled and retracted.

FIG. 16(a) and FIG. 16(b) illustrate a network architecture of the system 100, describing a flow of energy into and out of the system 100, in accordance with an embodiment of the present disclosure.

FIG. 16(a) depicts the case where energy is drawn from a grid 090, through a sub-station 092, and used to move the power rotor 002 to the charged position (either using the lifting mechanism, driving/actuating the motors on the hub sliding wheels 042, or by actuating any other mechanism using the electrical energy from the grid 090). The energy from the grid may be stored as potential energy in the power rotors 002. In FIG. 16(b), the power rotor 002 in the system 100 is allowed to drop or move from the second end/top or the position on the lifting post 001 to the first end/bottom (or a second position, in cases where the system 100 need not be fully discharged). As the power rotor 002 drops or moves, energy may be generated and sent through the sub-station 092, and the energy may be transmitted from the sub-station 092 to the grid 090. The components in the figure are not to scale and just representative of the underlying system.

The levelized cost of storage (LCOS) may be strongly influenced by the capital cost of the proposed system 100. Also, the LCOS may be influenced by the amount of energy stored, and number of charge-discharge cycles. The lack of self-discharge and extremely long life (>40 years) may allow the system 100 to have very low operating cost. In order to minimize the capital cost, existing water bodies such as reservoirs or unused lakes or ponds may be used to reduce the capital cost substantially. Similarly, re-using abandoned oil tanks for crude oil storage may also help reduce capital cost substantially. Where water tanks need to be built, using the same tanks built for storing crude oil in oil terminals may help reduce the cost and speed up development times. Hence, the energy storage and retrieval system of the present disclosure may be highly scalable, installable at a diverse set of geographical locations, low cost, and be simple to construct and maintain.

The foregoing descriptions of specific embodiments of the present disclosure have been presented for purposes of illustration and description. They are not intended to be exhaustive or to limit the inventive concept to the precise forms disclosed, and many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions or substitutions of equivalents are contemplated as circumstances may suggest or render expedient, but such changes are intended to cover the application or implementation without departing from the spirit or scope of the claims of the present disclosure.

1. An energy storage and retrieval system, comprising:
a lifting post comprising a rigid core and a rotator tube mounted on the rigid core, wherein the rotator tube is configured to rotate about the rigid core; and
one or more power rotors comprising:
a hub movably connected along the rotator tube of the lifting post, the hub being movable between a first end and a second end of the lifting post, and
a plurality of rotor blades attached to the hub, wherein the plurality of rotor blades are configured to rotate the rotator tube through the hub when the plurality of rotor blades interact with a fluid medium,
wherein the one or more power rotors are configured to store potential energy when moved towards the second end along the lifting post against a resistive force, and
wherein the plurality of rotor blades are configured to interact with the fluid medium when the one or more power rotors are released and allowed to move towards the first end by the resistive force, causing the potential energy to be converted to rotational motion of the rotator tube.

2. The energy storage and retrieval system of claim 1, wherein the resistive force is the force of gravity.

3. The energy storage and retrieval system of claim 1, wherein the resistive force is provided by an elastic resistance mechanism configured to bias the one or more power rotors towards the first end, the elastic resistance mechanism comprising a resilient component connected to the first end and the one or more power rotors.

4. The energy storage and retrieval system of claim 1, wherein the one or more power rotors are positionally locked on the lifting post to retain the potential energy on being moved away from the first end.

5. The energy storage and retrieval system of claim 1, further comprising a generator connected to the rotator tube, and configured to convert the rotational motion of the rotator tube into electrical energy.

6. The energy storage and retrieval system of claim 1, wherein the rotator tube is rotationally locked with a mechanical load, and thereby drive the mechanical load.

7. The energy storage and retrieval system of claim 1, wherein the rotator tube comprises a mechanical interface comprising any one or a combination of: a rotator tube gear, a belt drive mechanism, and one or more interlocking gears, the mechanical interface being configured to drive a generator for generating the electric power, and/or drive a mechanical load based on the rotational motion of the rotator tube.

8. The energy storage and retrieval system of claim 1, wherein each of the one or more power rotors is released sequentially and allowed to move towards the first end under the influence of the resistive force to convert the potential energy into the rotational motion and/or electrical energy.

9. The energy storage and retrieval system of claim 1, wherein more than one of the one or more power rotors are released simultaneously and allowed to move towards the first end under the influence of the resistive force to convert the potential energy into the rotational motion and/or electrical energy.

10. The energy storage and retrieval system of claim 1, wherein the rotator tube is mounted on the rigid core via one or more bearings to facilitate free rotation of the rotator tube about the rigid core.

11. The energy storage and retrieval system of claim 1, wherein the hub comprises one or more hub sliding wheels configured to facilitate movement of the hub between the first end and the second end, and configured to transfer torque from each of the plurality of the rotor blades to the rotator tube, for imparting the rotational motion to the rotator tube when each of the plurality of rotor blades rotates on interacting with the fluid medium.

12. The energy storage and retrieval system of claim 11, wherein the one or more hub sliding wheels are connected to a motor configured to move the one or more power rotors away from the first end to store potential energy on actuation.

13. The energy storage and retrieval system of claim 1, wherein each of the plurality of rotor blades is configured to furl and/or unfurl to change planform area of the one or more power rotors by pivoting about a rotor hinge connecting the plurality of the rotor blades to the hub, and wherein each of the plurality of rotor blades is furled when storing the potential energy, and unfurled during conversion of the potential energy to rotational motion.

14. The energy storage and retrieval system of claim 1, further comprising a fall-breaking mechanism mounted on the first end of the lifting post, and configured to decelerate the one or more power rotors on reaching the first end.

15. The energy storage and retrieval system of claim 14, wherein the fall-breaking mechanism comprises a fall breaker spring configured to decelerate the one or more power rotors when the hub of the one or more power rotors engages with the fall breaker spring when moving towards the first end of the lifting post.

16. The energy storage and retrieval system of claim 14, wherein the fall-breaking mechanism comprises a catching cushion configured to prevent direct contact between each of the plurality of rotor blades and the ground, and protects the one or more power rotors and each of the rotor blades.

17. The energy storage and retrieval system of claim 1, wherein the plurality of rotor blades comprise a telescopic rotor extender portion configured to telescopically extend from a rotor base of a portion of the hub.

18. The energy storage and retrieval system of claim 1, wherein the energy storage system is placed in a tank comprising the fluid medium, and wherein the fluid medium is water.

19. The energy storage and retrieval system of claim 1, further comprising a lifting mechanism comprising a winch configured to operably extend one or more mechanical grabbers by unspooling a corresponding winch cable, wherein the one or more mechanical grabbers are configured to hold a corresponding grabbing handle extending from the hub of the one or more power rotors, and wherein the winch is further configured to retract the one or more mechanical grabbers by spooling the corresponding winch cable to move the one or more power rotors away from the first end for storing potential energy.

20. An energy storage system, comprising:
one or more power rotors comprising one or more rotor blades extending from a hub rotatably and movably connected on a lifting post, wherein a resistance force acts on the one or more power rotors such that:
when the one or more power rotors are moved away from a first end of the lifting post against the resistance force, the one or more power rotors are configured to cause potential energy to be stored therein; and
when the one or more power rotors are moved towards the first end of the lifting post by the resistance force, the one or more power rotors are configured to convert the stored potential energy into rotational motion of the hub rotationally locked with a rotator tube of the lifting post.
